(19) United States
(12) Patent Application Publication
(10) Pub. No.: US 2013/0308218 A1
(43) Pub. Date: Nov. 21, 2013

(54) SOLAR CONDENSER

(71) Applicants: Kai Zhu, Xiangtan (CN); Minhui Wang, Xiangtan (CN); Yuelei Zhang, Xiangtan (CN)

(72) Inventors: Kai Zhu, Xiangtan (CN); Minhui Wang, Xiangtan (CN); Yuelei Zhang, Xiangtan (CN)

(73) Assignee: XIANGTAN ELECTRIC MANUFACTURING CO., LTD., Xiangtan (CN)

(21) Appl. No.: 13/981,515

(22) PCT Filed: Apr. 26, 2012
(86) PCT No.: PCT/CN12/74741

§ 371 Date: Jul. 24, 2013

(30) Foreign Application Priority Data
May 4, 2011 (CN) 201110114055.1
May 4, 2011 (CN) 201120137889.X

(51) Int. Cl. G02B 19/00

(52) U.S. Cl. CPC G02B 19/0023; G02B 19/0042
USPC 359/853

(57) ABSTRACT

A solar condenser, comprising two or more parabolic mirrors; each parabolic mirror is provided with a different focal length and a common focusing plane; the parabolic mirrors consist of a plurality of staggeredly arranged mirror unit groups consisting of more than one reflecting units; the distance between every two parabolic mirrors with different focal lengths is the focal length difference thereof. Through the staggered installation of the reflecting units, the air flow between the mirrors is increased without increasing additional footprint or affecting the light-focusing effect, thus the impact of winds on the mirrors and structures is reduced; and ice, snow and dust do not easily accumulate on the mirrors, thus effectively improving the operational stability of the solar condenser.

This application claims priority to Chinese patent application No. 201110114055.1 titled “A SOLAR CONDENSER” and filed with the State Intellectual Property Office on May 4, 2011 which is incorporated herein by reference in its entirety.

This application claims priority to Chinese patent application No. 201120137889.X titled “SOLAR CONDENSER” and filed with the State Intellectual Property Office on May 4, 2011 which is incorporated herein by reference in its entirety

### FIELD OF THE APPLICATION

The present application relates to a solar condenser and, in particular, to a solar condenser including two or more paraboloidal minors with different focal lengths and having the same focal plane.

### BACKGROUND OF THE APPLICATION

In a conventional paraboloidal condenser, a single revolution paraboloid having a single focal length generally consists of multiple small minors, and the diameter of this paraboloidal condenser is relatively large in order to satisfy an energy requirement for collecting light. Therefore, the surface of the condenser may become a large windward surface when the system meets with a large wind during operation. Thus, the accuracy of the condenser and the strength of a supporter may be affected by the wind, and the condenser and the supporter may be damaged in a serious case. In addition, since gaps between the mirrors are small, which are generally 10 to 20 mm, it is not easy for snow, dust or the like to drop through the gaps. All these factors may affect the usage and maintenance of the mirror.

### SUMMARY OF THE APPLICATION

An object of the present application is to provide a solar condenser including two or more paraboloidal mirrors having different focal lengths, the paraboloidal mirrors being installed such as to have the same focal plane. The solar condenser may reduce the effect of wind on the minors, and not be easily accumulated with ice, snow and dust on mirrors, and improve the operational stability of the condenser effectively.

A technical solution of the present application includes a light collecting mirror. The converging lens includes two or more paraboloidal minors having different focal lengths and mounted in such a manner to have a same focal plane. Each of the paraboloidal mirrors is formed by staggeredly arranging minor unit groups including one or more reflecting unit. The distance between every two paraboloidal minors having different focal lengths is a difference between the focal lengths of the two paraboloidal minors.

The reflecting unit is a glass minor or reflecting film having specular reflection performance.

Each of the one or more reflecting unit has a sector shape, a trapezoidal shape or any other geometrical shape.

Each of the minor unit groups of each paraboloidal minor is formed by arranging the reflecting units of the paraboloidal minor in a radial direction of the condenser, and two adjacent minor unit groups having different focal lengths are staggeredly arranged in a circumferential direction of the condenser.

Each of the minor unit groups of each paraboloidal minor is formed by arranging the reflecting units of the paraboloidal minor in a circumferential direction of the condenser, and two adjacent minor unit groups having different focal lengths are staggeredly arranged in a radial direction of the condenser.

The reflecting units of the paraboloidal minor are staggeredly arranged in the radial and circumferential directions of the condenser.

In the present application, without increasing additional occupied area and affecting the light collecting effect, air leakage between minors may be increased by staggeredly installing the reflecting units since the focal lengths of the reflecting units of two or more paraboloidal minors are different, thereby reducing the effect of wind on the minors and structures and ice, difficulty being accumulated with snow and dust on the minors, and improving the operational stability of the condenser effectively.

### BRIEF DESCRIPTION OF THE DRAWINGS

FIG. 1 is a schematic diagram showing the principle of the present application;

FIG. 2 is a schematic diagram of a structure according to a first embodiment;

FIG. 3 is a top view of the first embodiment;

FIG. 4 is a schematic diagram of a structure according to a second embodiment; and

FIG. 5 is a schematic diagram of a structure according to a third embodiment.

### DETAILED DESCRIPTION OF THE APPLICATION

In the following, the present application will be described further in conjunction with accompanying drawings and specific embodiments which are not intended to limit the present application.

The working principle of the present application is described below.

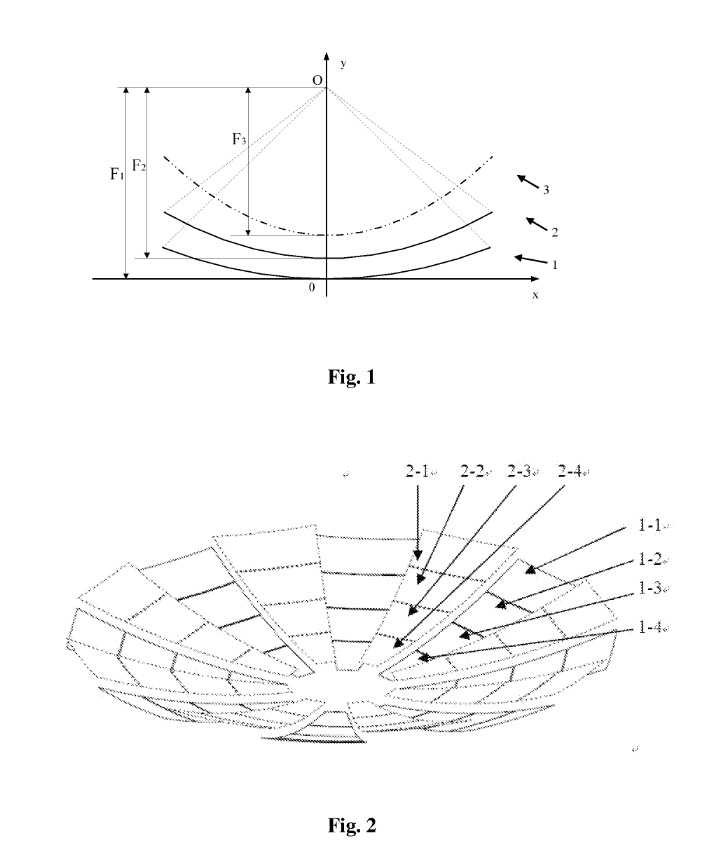

Referring to FIG. 1, one condenser includes a paraboloidal mirror 1, a paraboloidal minor 2 and a paraboloidal mirror 3. Although the three paraboloidal mirrors have different focal lengths, for example, the focal length of the paraboloidal mirror 1 is F₁, the focal length of the paraboloidal mirror 2 is F₂ and the focal length of the paraboloidal mirror 3 is F₃, the focal planes of these paraboloidal mirrors all coincide with a plane going through the point O and being perpendicular to the y-axis. Therefore, there are certain distances between these paraboloidal minors in a center line direction, and the distances are the differences between the focal lengths of the paraboloidal minors.

### First Embodiment

Referring to FIG. 2, a condenser includes a paraboloidal minor 1 and a paraboloidal minor 2. In the paraboloidal minor 1, a minor unit group of the paraboloidal minor 1 includes four reflecting units 1-1 to 1-4 arranged in a radial direction with the condenser center as a reference.

In the paraboloidal mirror 2, a minor unit group of the paraboloidal mirror 2 includes four reflecting units 2-1 to 2-4 arranged in a radial direction with the condenser center as a reference. When the reflecting units are arranged in a circumferential direction of the condenser, the minor unit group of the paraboloidal minor 1 with the focal length F₁ and the minor unit group of the paraboloidal minor 2 with the focal length F₂ are staggeredly arranged. In this way, since the focal lengths of the paraboloidal minor 1 and the paraboloidal minor 2 are different, a larger gap is formed, so as to increase air leakage between the mirrors, thereby reducing the effect of wind, snow or dust on the mirrors and the structure effectively.

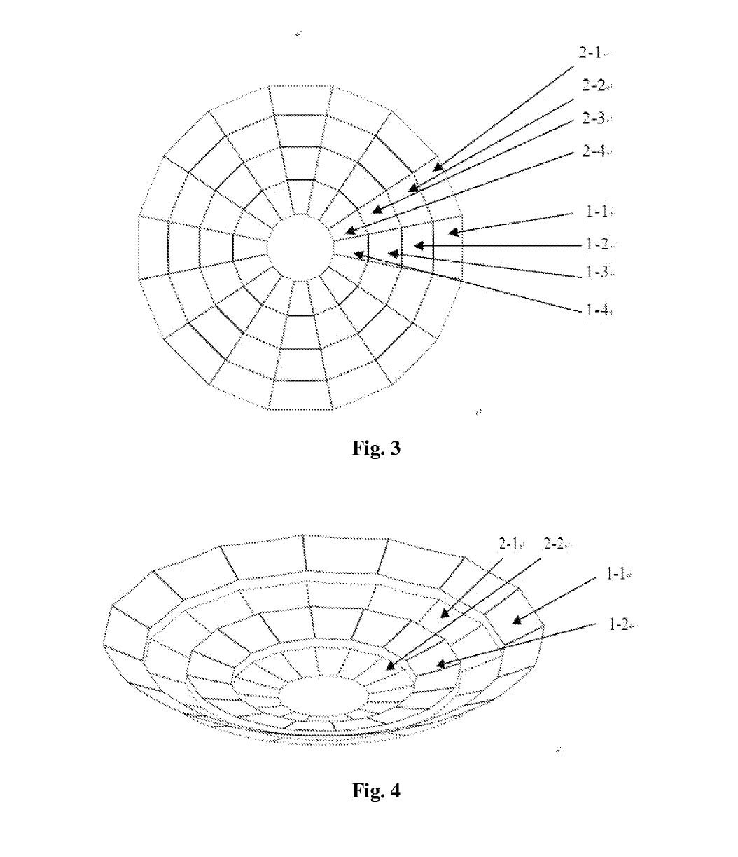

Referring to FIG. 3, since the reflecting units of the paraboloidal mirrors are staggeredly arranged with each other, the reflecting units do not be shaded each other when facing to the sun. Thus, such arrangement of reflecting units may not affect the light collecting effect.

### Second Embodiment

Referring to FIG. 4, the second embodiment is different from the first embodiment in that: a minor unit group of the paraboloidal minor 1 is formed by arranging 16 reflecting units 1-1 of the paraboloidal minor 1 in the circumferential direction of the condenser; and the other minor unit group of the paraboloidal minor 1 is formed by arranging 16 reflecting units 1-2 of the paraboloidal minor 1 in the circumferential direction of the condenser. A minor unit group of the paraboloidal minor 2 is formed by arranging 16 reflecting units 2-1 of the paraboloidal minor 2 in the circumferential direction of the condenser; and the other minor unit group of the paraboloidal minor 2 is formed by arranging 16 reflecting units 2-2 of the paraboloidal minor 2 in the circumferential direction of the condenser. When the reflecting units are arranged in the radial direction of the condenser, gaps are formed by staggeredly arranging the minor unit group of the paraboloidal minor 1 with the focal length F₁ and the minor unit group of the paraboloidal minor 2 with the focal length F₂.

### Third Embodiment

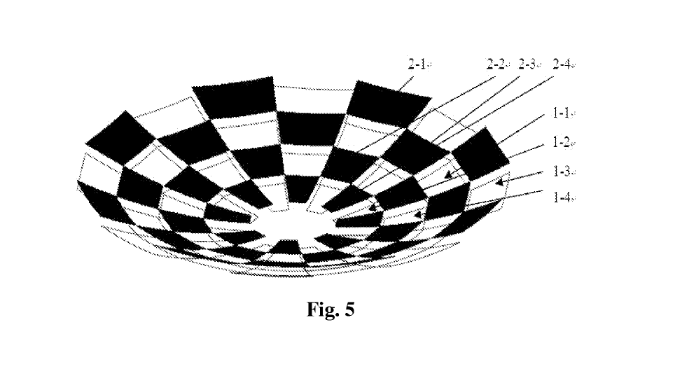

Referring to FIG. 5, the third embodiment is different form the above embodiments in that: in the embodiment, gaps are formed by staggeredly arranging various reflecting units with different focal lengths in both the radial and circumferential directions of the condenser.

The foregoing relates only to the preferable embodiments of the present application and is not intended to limit the present application. For those skilled in the art, various modifications and variations to the present application may be made. For example, the number of the reflecting units of the paraboloidal mirror in the radial and circumferential directions of the condenser may be adjusted in light of a design, and the shape thereof may also be in other shapes, as long as one condenser including paraboloidal minors with different focal lengths is formed finally. Such modifications and variations fall into the scope of protection claimed by the present patent. Any arranging changes, modifications, equivalent substitutions, improvements and the like made within the spirit and principles of the present application are all contained in the scope of protection of the present application.

1. A solar condenser, comprising a light collecting mirror, wherein the light collecting mirror comprises two or more paraboloidal minors having different focal lengths and mounted in such a manner to have a same focal plane; each of the paraboloidal minors is formed by staggeredly arranging minor unit groups comprising one or more reflecting unit; and the distance between every two paraboloidal minors having different focal lengths is a difference between the focal lengths of the two paraboloidal minors.

2. The solar condenser according to claim 1, wherein, the reflecting unit is a glass minor or reflecting film having specular reflection performance.

3. The solar condenser according to claim 1, wherein, each of the one or more reflecting unit has a sector shape, a trapezoidal shape or any other geometrical shape.

4. The solar condenser according to claim 1, wherein, each of the minor unit groups of each paraboloidal minor is formed by arranging the reflecting units of the paraboloidal minor in a radial direction of the condenser, and two adjacent minor unit groups having different focal lengths are staggeredly arranged in a circumferential direction of the condenser.

5. The solar condenser according to claim 1, wherein, each of the minor unit groups of each paraboloidal minor is formed by arranging the reflecting units of the paraboloidal minor in a circumferential direction of the condenser, and two adjacent mirror unit groups having different focal lengths are staggeredly arranged in a radial direction of the condenser.

6. The solar condenser according to claim 1, wherein, the reflecting units of the paraboloidal minors are staggeredly arranged in a radial direction and a circumferential direction of the condenser.
